(19) United States
(12) Patent Application Publication
(10) Pub. No.: US 2014/0209192 A1
(43) Pub. Date: Jul. 31, 2014

(54) Canine Security Deterrent

(71) Applicant: Jimmy Wayne Lawrence, Upper Marlboro, MD (US)

(72) Inventor: Jimmy Wayne Lawrence, Upper Marlboro, MD (US)

(21) Appl. No.: 13/751,051

(22) Filed: Jan. 26, 2013

(51) Int. Cl. A01K 15/02

(52) U.S. Cl. CPC A01K 15/02
USPC 137/565.01

(57) ABSTRACT

The device provides mechanism for aiding scent detection canine to detect explosive or other contraband that are deemed to be in a person's possession. The device operates upon the idea of air tracking. The person enters in a collapsible non-porous covered metal frame, stands directly under a 2 by 2 plastic exhaust fan that pushes air down the person's body. At the bottom of the device are 2 vents with 2×2 dimensions on each side with 2×2 fans that draw the air out into a 1×1 silver foil exhaust tube. A 4×4 non-porous box with an opening is connected to the exhaust tube for the canine to sniff the air and alert his handler if there is a presence of explosive or other contraband. The person will then exit at the back of the device.

### DESCRIPTION OF THE DRAWINGS

FIG. 1 is a perspective view of the present design for a Canine Security Deterrent;

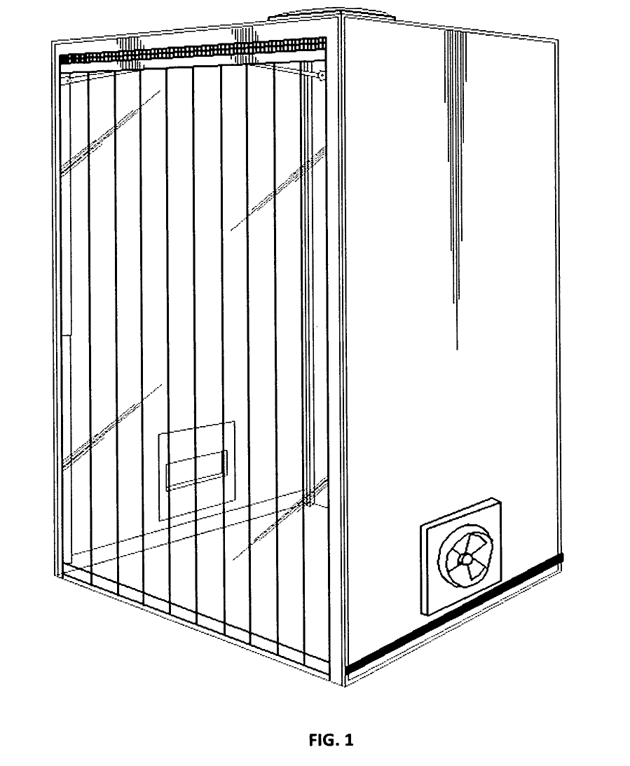

FIG. 2 is a front view;

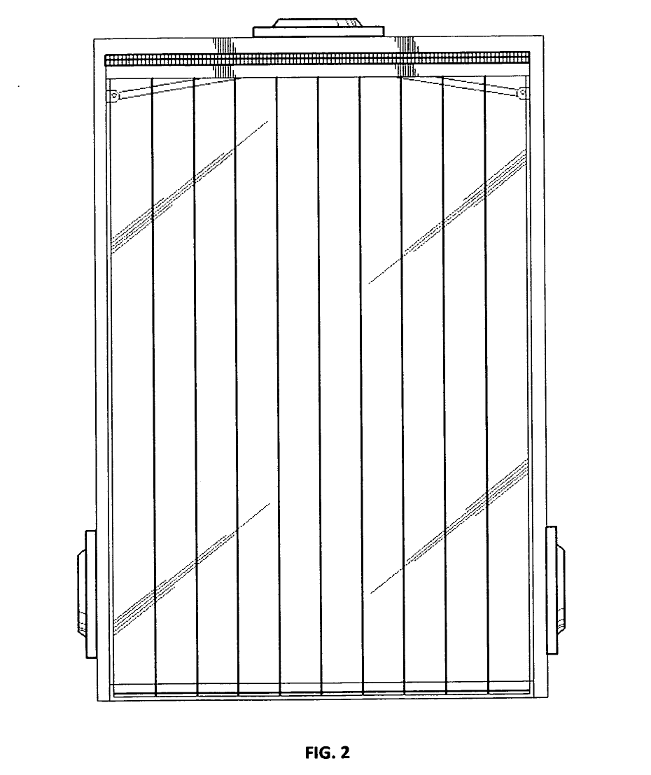

FIG. 3 is a side view;

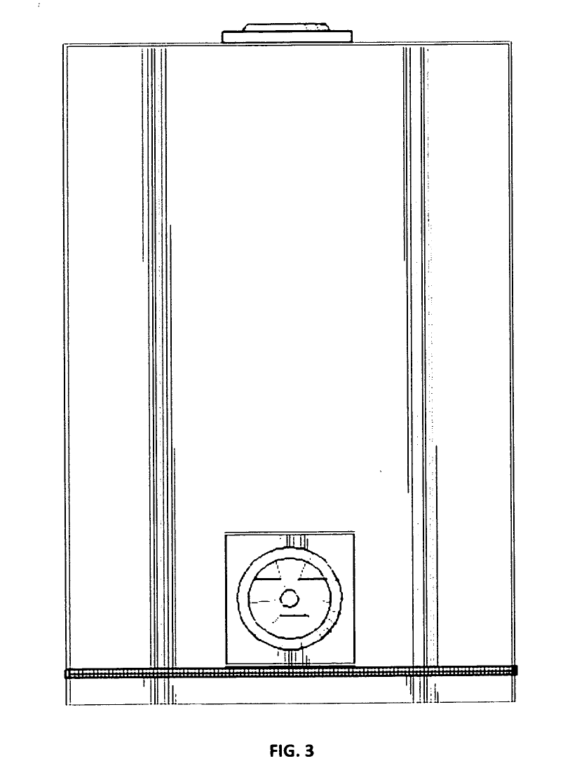

FIG. 4 is a top view, and

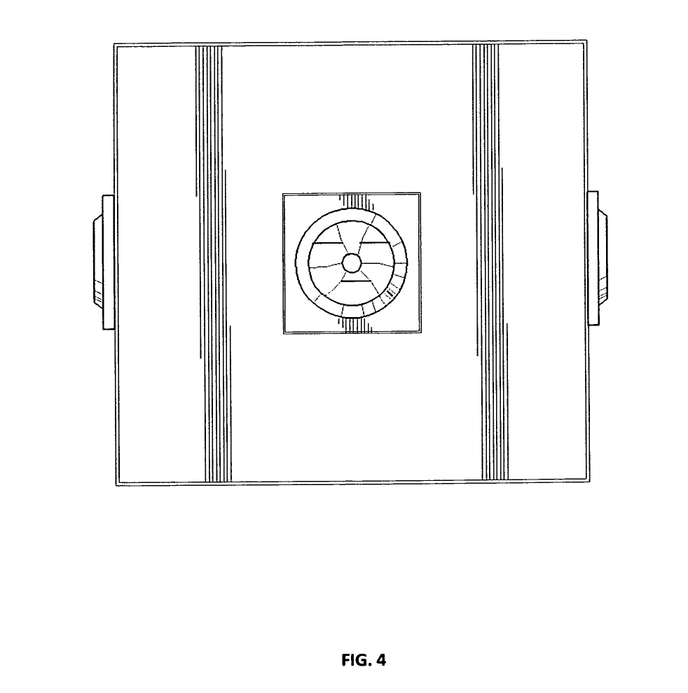

FIG. 5 is a rear view of the same.

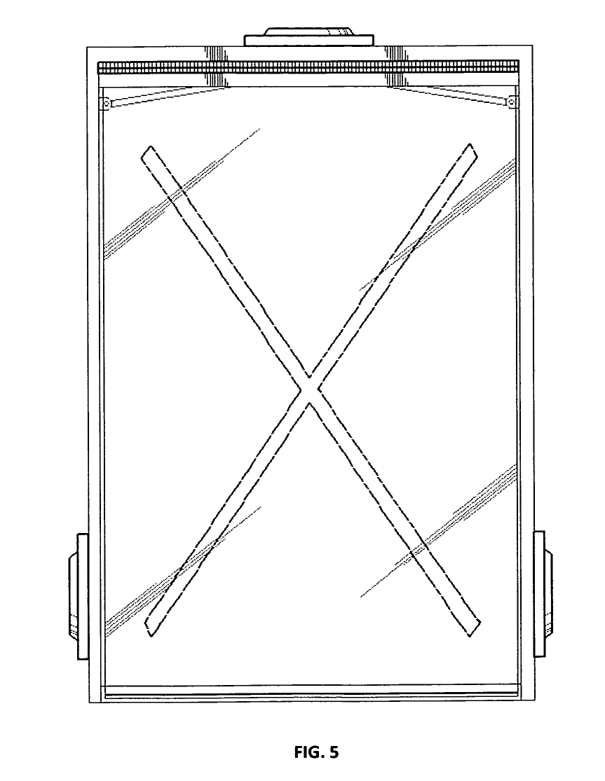

### CLAIM

The ornamental design for a Canine Security Deterrent substantially as shown in the drawings.

We claim:

1. A device comprising:
An enclosure to encapsulate and isolate the scent of a person or object to aide in the scent detection of a trace substance.
A fan or blower induction system and/or an exhaust fan or port to direct a potential scent towards a predetermined area for canine scent detection.
